(19) United States
(12) Patent Application Publication
(10) Pub. No.: US 2021/0369022 A1
(43) Pub. Date: Dec. 2, 2021

(54) Anchoring Assembly

(71) Applicant: Mayborn (UK) Limited, Newcastle upon Tyne (GB)

(72) Inventors: Ian Tennick, Newcastle upon Tyne (GB); Nicholas Cudworth, Newcastle upon Tyne (GB)

(21) Appl. No.: 16/763,877

(22) PCT Filed: Nov. 13, 2018
(86) PCT No.: PCT/GB2018/053267

§ 371 Date: May 13, 2020

(30) Foreign Application Priority Data
Nov. 14, 2017 (GB) 1718813.7

(51) Int. Cl. A47G 19/22; A47G 23/02; F16B 47/00

(52) U.S. Cl. CPC A47G 19/2261; F16B 47/00; A47G 23/0225

(57) ABSTRACT

The invention relates to an assembly (150) for anchoring a vessel (100) to a reference surface (102). The assembly (150) comprises a sealing element holder (106) for coupling to a vessel (100) and a sealing element (104) coupled to the sealing element holder (106), wherein a portion of the sealing element (104) is moveable relative to the sealing element holder (106). A base member (108) is located proximate to the sealing element holder (106) in use and a diaphragm element (112) is coupled to the base member (108) for engagement with a reference surface (102). The base member (108) comprises upper (142) and lower surfaces (144), including a sealing surface (110) on the upper surface (144) and a channel (140) extending from the upper surface (144) to the lower surface (142). The sealing element holder (106) is moveable relative to the base member (108) between first and second positions and the assembly is configured such that when the diaphragm element (112) is engaged with the reference surface (102) and the sealing element holder (106) is in the first position the sealing element (104) will engage with the sealing surface (110) thereby forming a sealed space between the reference surface (102) and the sealing element (104) to anchor the assembly (150) to the reference surface (102), and the assembly is configured such that when the sealing element holder (106) is in the second position the diaphragm (112) is removable from the reference surface (102).

The present invention relates to an assembly for anchoring a vessel to a reference surface.

In many situations, it is preferable that vessels holding solids, liquids or a mix thereof do not spill their contents. This is of particular concern for vessels for holding sustenance, i.e. food or drink, such as drinking cups, drinking flasks, bowls, plates or the like. Some vessels, for example drinking cups or tumblers, are tall in profile, such that when full they are unstable and prone to tipping upon application of a lateral load due to the high centre of gravity.

U.S. Pat. No. 5,511,752 discloses a cap mounted upon a stem of a suction cup, axially repositionable by axial and/or tilting movement relative to the stem to selectively close or open fluid communication between the concave space defined by the cup element of the suction cup and the ambient environment.

U.S. Pat. Nos. 8,025,169 and 8,028,850 disclose a self-anchoring beverage container with directional release and attachment capability having a flexible nonporous base member adapted to seal to a reference surface and create a controlled pressure zone.

Container assemblies such as those described in U.S. Pat. Nos. 8,025,169 and 8,028,850 can require a tight fit between components within the assembly to avoid the vacuum seal being broken unnecessarily due to slight wobbles of the vessel. If the seal is broken without the user being aware, then they may not realise that the vessel is not secured to the reference surface and the vessel could still be knocked over. Failure to meet the required tolerance between components within the assembly may reduce (or entirely prevent), an adequate seal being created between the assembly and the reference surface. This places unrealistic demands on the manufacture of the assembly.

Moreover, the handle of such assemblies can be accidentally knocked leading to breaking of the seal. Such assemblies also require additional components to prevent excessive relative movement between the inner cup and outer shell of the assembly (i.e. a stopper), which may lead to detachment of the inner cup from the outer shell. To manufacture an assembly including such a ‘stopper’ component, reduces the efficiency of the manufacturing process. In addition, such a component may become a weak spot after repeated use.

Such assemblies rely on a tight fit between an outer shell and the inner cup so there is effectively a ‘double-walled’ container for no other reason than to ensure a tight fit between the parts. That is, the means for self-anchoring the beverage container occupies substantially the full-length of the container. Thus, the arrangement requires a significant additional amount of material, increasing costs.

Current ‘single walled’ assemblies, can require complex arrangements and/or additional components to allow a degree of relative movement between an assembly and a corresponding vessel before the seal is broken.

U.S. Pat. No. 8,757,418 discloses a self-anchoring, low profile container anchor with directional release and attachment capability, comprising a lower base member, an upper movable member adapted for attachment to a container, and a seal member on the base member. The seal member is configured to engage an external reference surface and form a substantially airtight seal therewith that defines a periphery of a controlled pressure zone.

According to a first aspect of the present invention there is provided an assembly for anchoring a vessel to a reference surface, the assembly comprising:
a sealing element holder for coupling to a vessel;
a sealing element coupled to the sealing element holder, wherein a portion of the sealing element is moveable relative to the sealing element holder;
a base member located proximate to the sealing element holder in use; and
a diaphragm element coupled to the base member for engagement with a reference surface;
   wherein the base member comprises:
upper and lower surfaces;
a sealing surface on the upper surface; and
a channel extending from the upper surface to the lower surface;
   wherein the sealing element holder is moveable relative to the base member between first and second positions;
   wherein the assembly is configured such that when the diaphragm element is engaged with the reference surface and the sealing element holder is in the first position the sealing element will engage with the sealing surface thereby forming a sealed space between the reference surface and the sealing element to anchor the assembly to the reference surface, and
   wherein the assembly is configured such that when the sealing element holder is in the second position the diaphragm is removable from the reference surface.

Aptly, a further portion of the sealing element is fixed relative to the sealing element holder.

Aptly, the portion of the sealing element moveable relative to the sealing element holder is a central portion of the sealing element.

Aptly, the sealing element holder includes an axial opening, wherein in use the sealing element is received in the axial opening.

Aptly, the sealing element is a resilient sealing element.

Aptly, the assembly is configured such that as the sealing element holder moves from first to second positions the sealing element deforms to remain engaged with the sealing surface.

Aptly, the sealing surface is an annular ridge.

Aptly, the sealing element includes an annular ridge, for sealably engaging with the sealing surface.

Aptly, the sealing element is substantially domed.

Aptly, when the sealing element holder is in the second position the sealing element is not engaged with the sealing surface.

Aptly, wherein the sealing element holder is configured to move from the first position to the second position upon movement away from the reference surface.

Aptly, wherein the base member is at least partially surrounded by the sealing element holder in use.

Aptly, wherein the base member is coaxial with the sealing element holder in use.

Aptly, wherein at least one of the sealing element holder or the base member comprises locating means configured to limit relative rotation therebetween.

Aptly, wherein in use the base member is coupled to the sealing element holder.

Aptly, wherein the sealing element holder is configured to couple to the vessel by being integrally formed with the vessel.

Aptly, wherein the sealing element holder is configured to couple to the vessel by engaging with a surface of the vessel.

Aptly, wherein the sealing element holder is configured to couple to the vessel by being threadably engaged with a surface of the vessel.

Aptly, wherein the sealing element comprises an elastomeric material.

Aptly, wherein the sealed space is at least partially defined by the sealing element, the diaphragm element and the reference surface.

Aptly, wherein the diaphragm element is secured to the base member at a position substantially proximate a central region of the lower surface of the base member.

Aptly, wherein the diaphragm element extends across substantially most of the lower surface of the base member.

According to a second aspect of the present invention there is provided an assembly for anchoring a vessel to a reference surface, wherein the vessel includes a sealing element holder having a sealing element coupled thereto, wherein a portion of the sealing element is moveable relative to the sealing element holder, the assembly comprising:
a base member for locating proximate to a sealing element holder coupled to a vessel in use, wherein the sealing element holder is moveable relative to the base member between first and second positions; and
a diaphragm element coupled to the base member for engagement with a reference surface;
   wherein the base member comprises:
upper and lower surfaces;
a sealing surface on the upper surface; and
a channel extending from the upper surface to the lower surface;
   wherein the assembly is configured such that when the diaphragm element is engaged with the reference surface and the sealing element holder is in the first position the sealing element will engage with the sealing surface thereby forming a sealed space between the reference surface and the sealing element to anchor the assembly to the reference surface, and
   wherein the assembly is configured such that when the sealing element holder is in the second position the diaphragm is removable from the reference surface.

According to a third aspect of the present invention there is provided an assembly for anchoring a vessel to a reference surface, the assembly comprising:
a vessel;
a sealing element holder coupled to the vessel;
a sealing element coupled to the sealing element holder, wherein a portion of the sealing element is moveable relative to the sealing element holder;
a base member located proximate to the sealing element holder in use; and
a diaphragm element coupled to the base member for engagement with a reference surface;
   wherein the base member comprises:
upper and lower surfaces;
a sealing surface on the upper surface; and
a channel extending from the upper surface to the lower surface;
   wherein the sealing element holder is moveable relative to the base member between first and second positions;
   wherein the assembly is configured such that when the diaphragm element is engaged with the reference surface and the sealing element holder is in the first position the sealing element will engage with the sealing surface thereby forming a sealed space between the reference surface and the sealing element to anchor the assembly to the reference surface, and
   wherein the assembly is configured such that when the sealing element holder is in the second position the diaphragm is removable from the reference surface.

Aptly, the vessel is any of a drinking vessel, a bowl or a plate.

According to a fourth aspect of the present invention there is provided a kit of parts for anchoring a vessel to a reference surface, the kit of parts comprising:
a sealing element holder for coupling to a vessel;
a sealing element for coupling to the sealing element holder, wherein a portion of the sealing element is moveable relative to the sealing element holder in use;
a base member for locating proximate to the sealing element holder in use; and
a diaphragm element for coupling to the base member for engagement with a reference surface;
   wherein the base member comprises:
upper and lower surfaces;
a sealing surface on the upper surface; and
a channel extending from the upper surface to the lower surface;
wherein in use the sealing element holder is moveable relative to the base member between first and second positions;
wherein in use the assembled kit of parts is configured such that when the diaphragm element is engaged with the reference surface and the sealing element holder is in the first position the sealing element will engage with the sealing surface thereby forming a sealed space between the reference surface and the sealing element to anchor the assembled kit of parts to the reference surface, and
wherein in use the assembled kit of parts is configured such that when the sealing element holder is in the second position the diaphragm is removable from the reference surface.

Certain embodiments provide an assembly for anchoring a vessel to a reference surface to prevent the spillage of the contents of the vessel.

Certain embodiments provide the advantage that the assembly requires fewer components than known systems and is therefore easier to manufacture and assemble.

Certain embodiments provide the advantage that the assembly fits underneath the vessel, reducing material usage compared to known systems.

Certain embodiments provide the advantage that no additional mechanism is required to allow a degree of relative movement between the base member and the sealing element holder without the seal being broken (for example to allow minor knocks to the vessel/tableware without the seal being broken). That is, the configuration of the sealing element allows a degree of relative movement between the sealing element holder and the base member, while maintaining the seal and it is the tolerance between these components only that is relevant to the breaking of the seal. This ensures a less complex assembly compared to known arrangements, which can be more easily controlled for small parts with small dimensions.

Embodiments are further described hereinafter with reference to the accompanying drawings, in which:

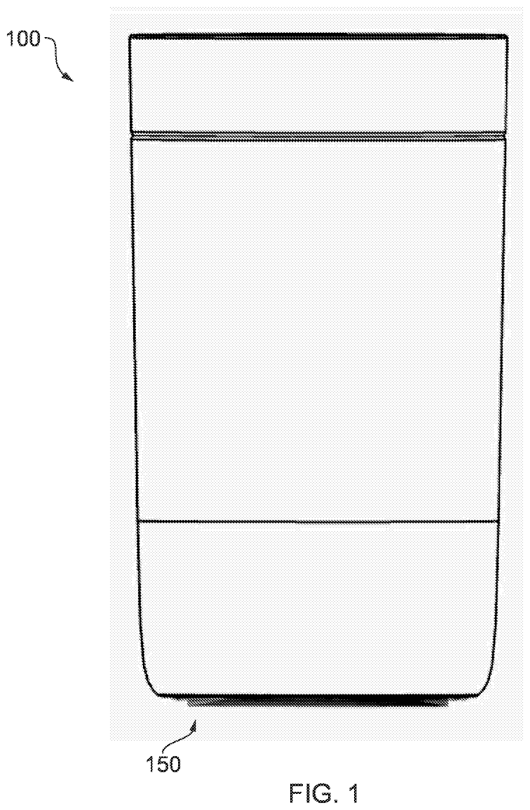

FIG. 1 illustrates a side view of a vessel and an example of an assembly for anchoring the vessel to a reference surface;

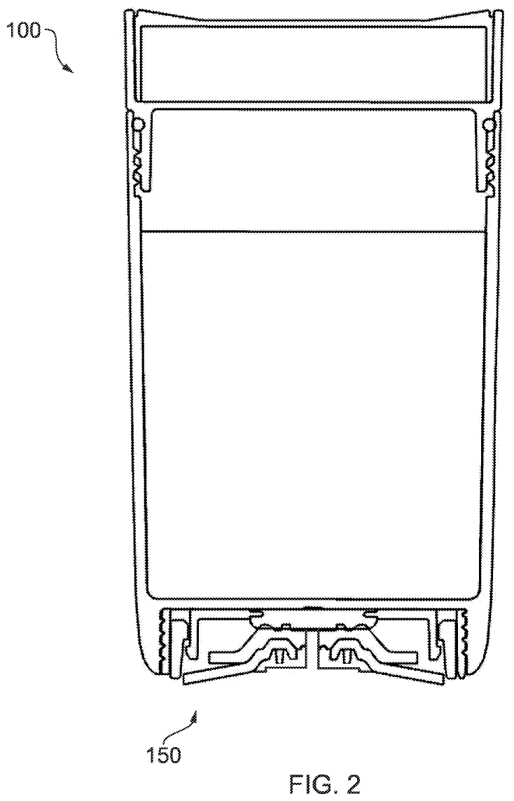

FIG. 2 illustrates a cross-sectional view of the vessel and assembly of FIG. 1;

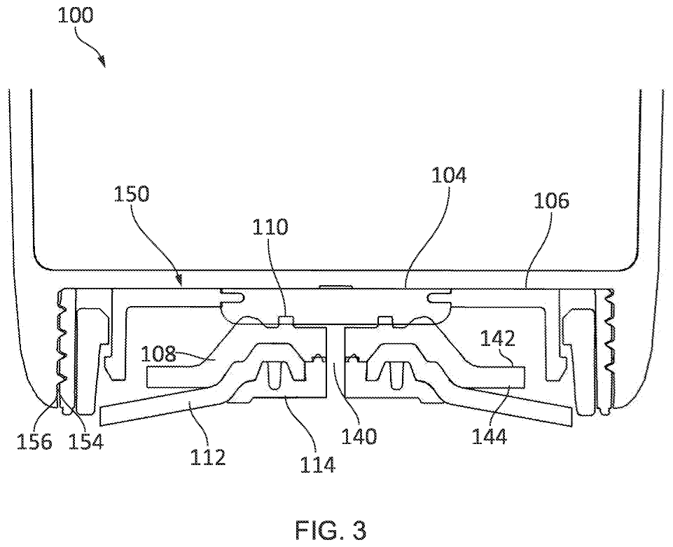

FIG. 3 illustrates a close up view of the assembly as shown in FIG. 2;

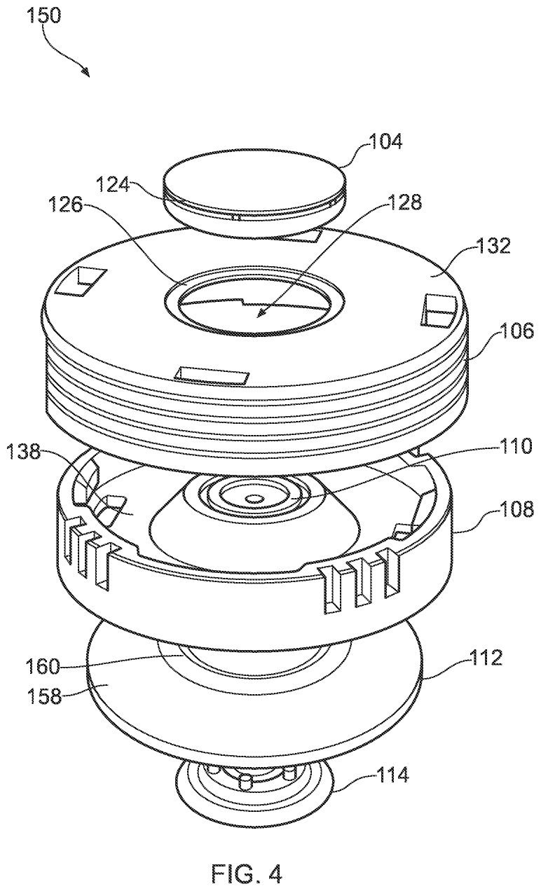

FIG. 4 illustrates an exploded perspective view of the assembly of FIGS. 1-3;

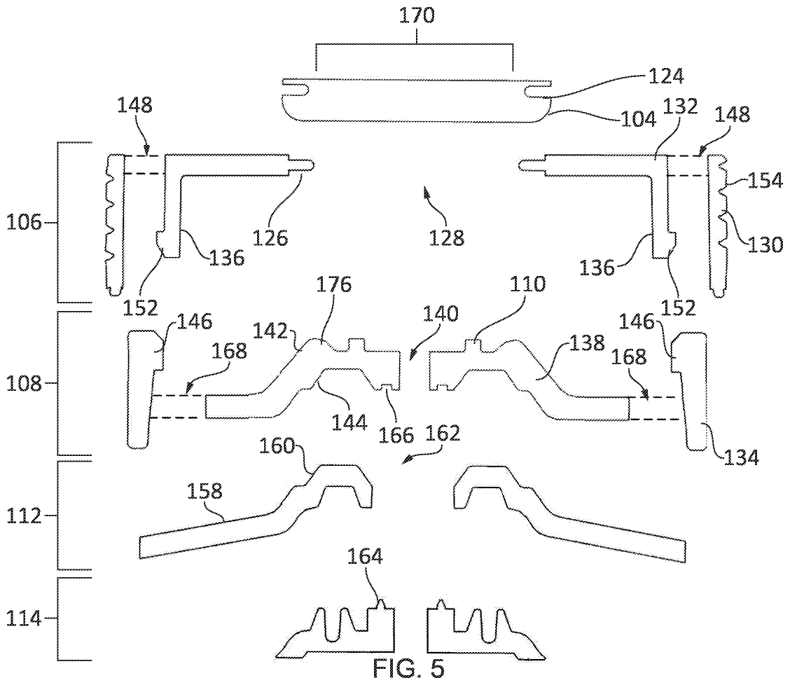

FIG. 5 illustrates an exploded cross-section view of the assembly of FIGS. 1-4;

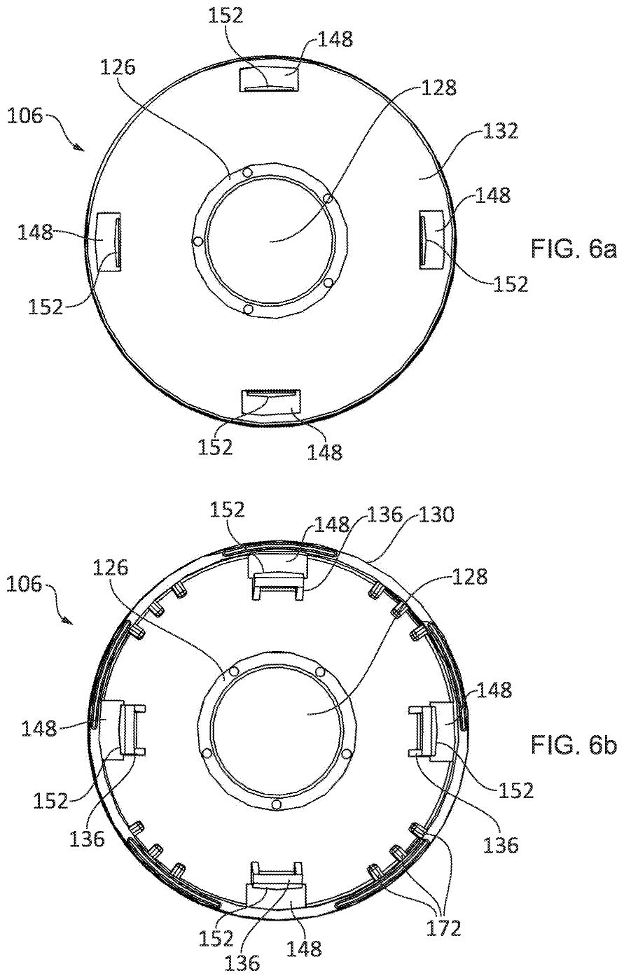

FIGS. 6a and 6b illustrate a plan view of the top and bottom, respectively, of a sealing element holder of the assembly of FIGS. 1-5;

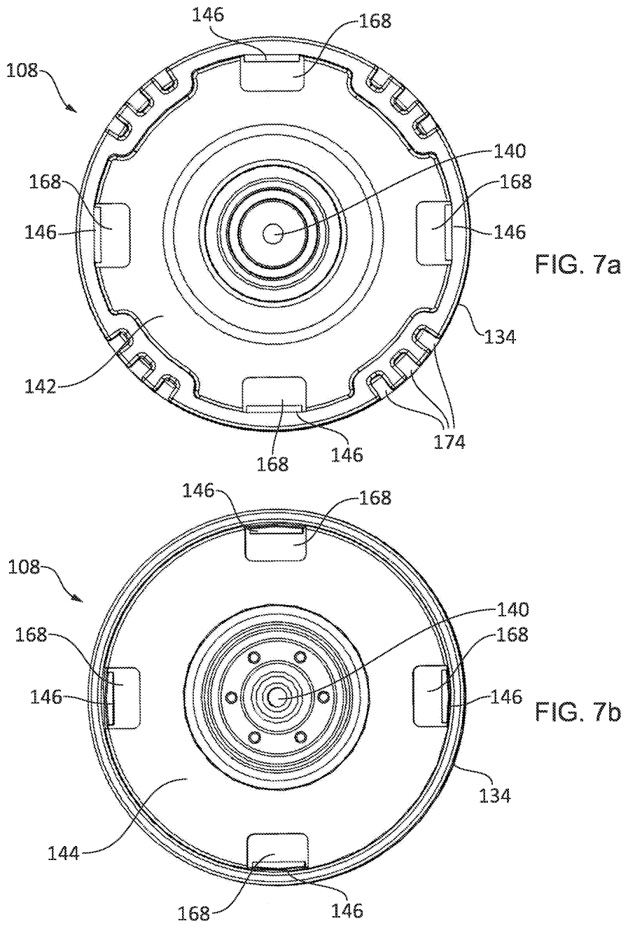

FIGS. 7a and 7b illustrate a plan view of the top and bottom, respectively, of a base member of the assembly of FIGS. 1-5;

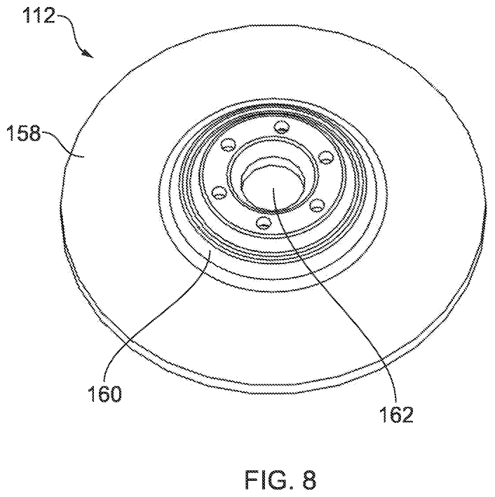

FIG. 8 illustrates a perspective view of a diaphragm member of the assembly of FIGS. 1-5;

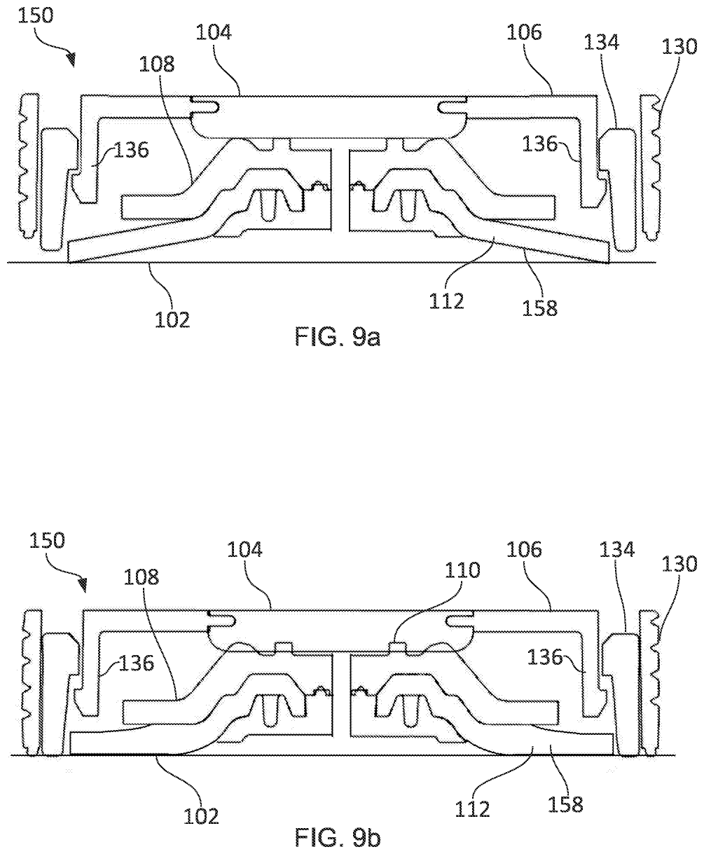

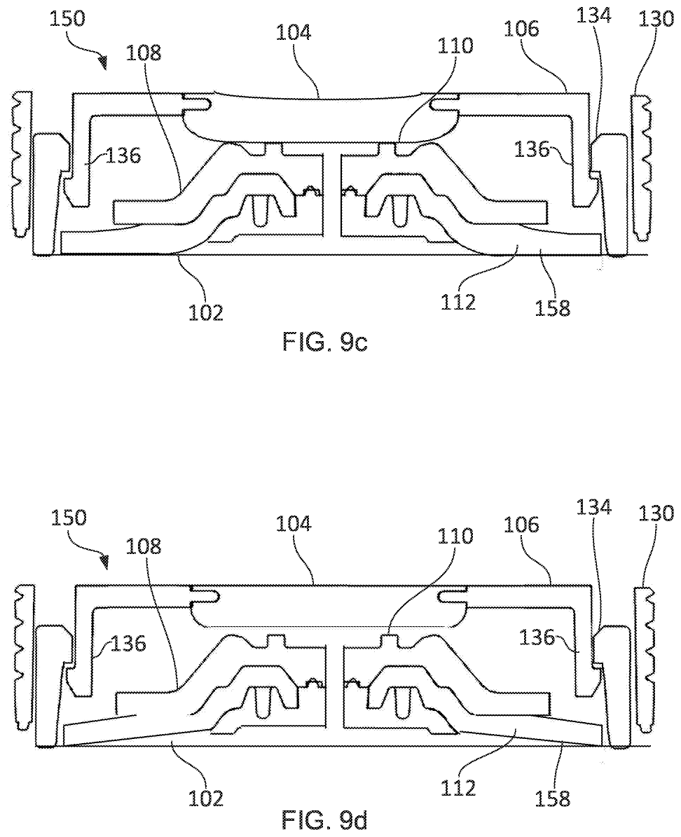

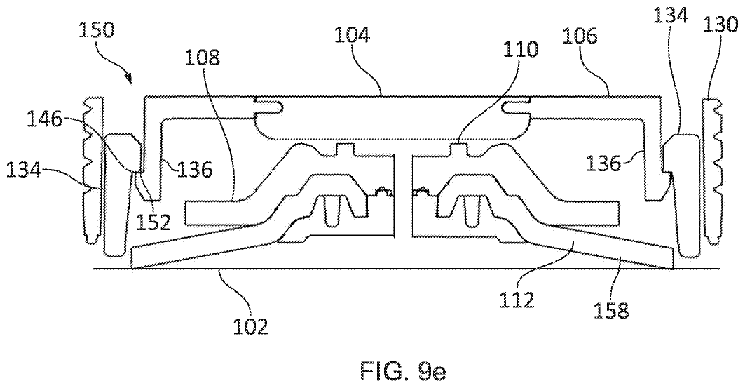

FIG. 9a-9b illustrate the steps taken to bring the assembly into a sealing configuration with a reference surface;

FIG. 9c-9e illustrate the steps taken to bring the assembly out of the sealing configuration with the reference surface;

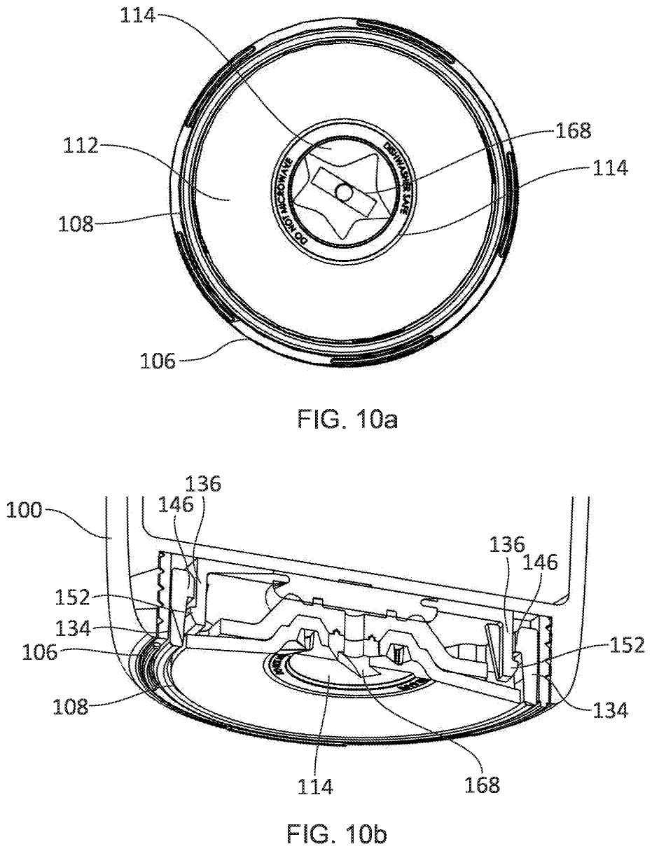

FIG. 10a illustrates a plan view of an underside of another assembly for anchoring a vessel to a reference surface including a removal slot;

FIG. 10b illustrates a cross-sectional perspective view of the assembly of FIG. 10a;

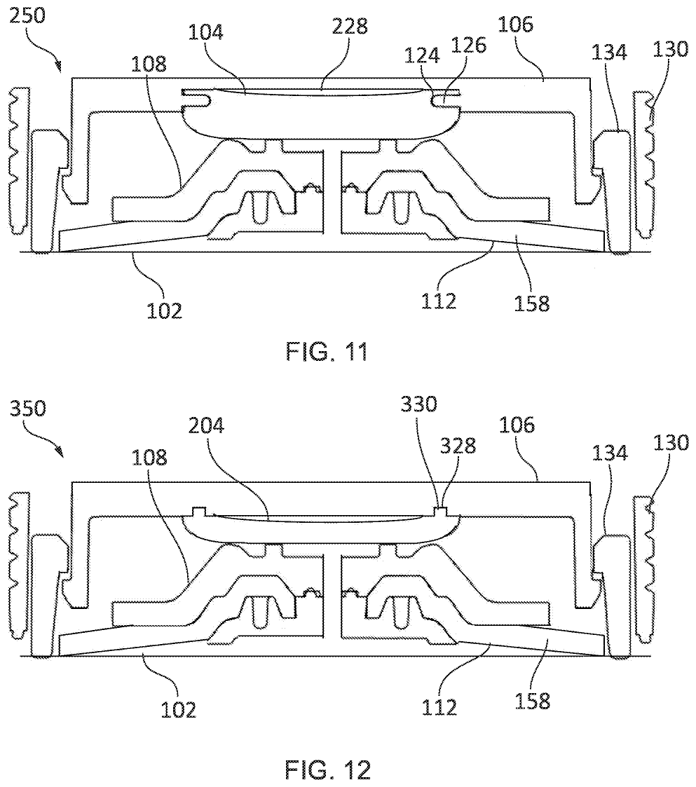

FIG. 11 illustrates a cross-sectional view of another assembly for anchoring a vessel to a reference surface;

FIG. 12 illustrates a cross-sectional view of another assembly for anchoring a vessel to a reference surface;

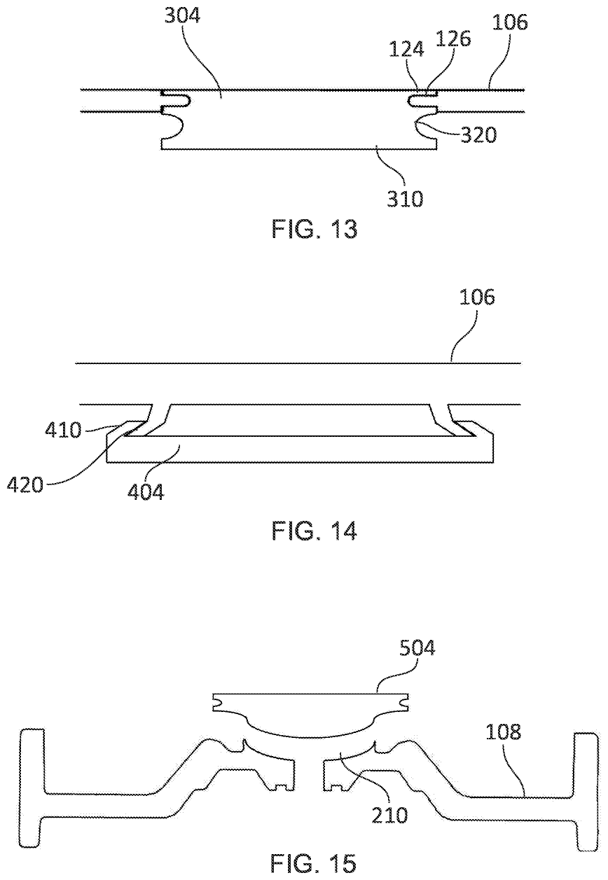

FIG. 13 illustrates a cross-sectional view of another example of a sealing element;

FIG. 14 illustrates a cross-sectional view of another example of a sealing element;

FIG. 15 illustrates a cross-sectional view of another example of a base member;

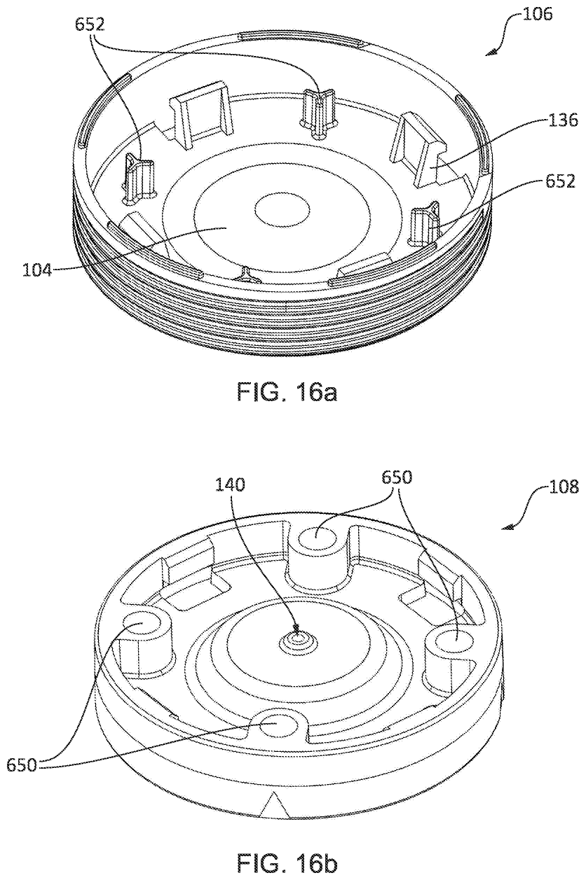

FIG. 16a-16b illustrate exploded perspective views, respectively, of another example of a sealing element holder and a base member; and

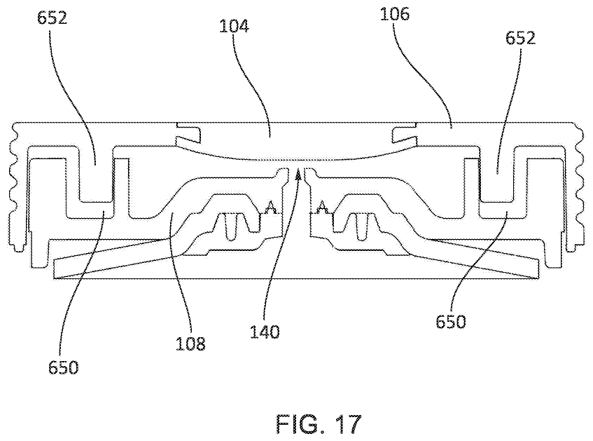

FIG. 17 illustrates a cross-sectional view of the assembly of FIGS. 16a-16b.

In the drawings like reference numerals refer to like parts.

Herein, reference to a vessel includes any vessel, tableware or crockery suitable for containing food, drink or the like, e.g. a drinking vessel (including tumblers, mugs and cups), plates and bowls.

FIGS. 1 to 3 illustrate a vessel 100 and an example of an assembly 150 for anchoring the vessel to a reference surface (e.g. a table top) according to the present invention.

The assembly includes a sealing element holder 106 for coupling to the vessel 100 and a sealing element 104 coupled to the sealing element holder 106.

The assembly further includes a base member 108. The base member 108 includes upper and lower surfaces 142,144, a sealing surface 110 on the upper surface, and a channel 140 extending from the upper surface to the lower surface.

The assembly further includes a diaphragm element 112 coupled to the base member 108 for engagement with a reference surface.

FIGS. 4 and 5 illustrate exploded views of the assembly 150.

In this example, the sealing element 104 is a resilient sealing element. That is, the sealing element 104 will retain its shape following application and subsequent release of a tensile/compressive force.

In this example, the sealing element 104 is formed from elastomeric material. In this example the sealing element 104 is a co-polymer, for example TPE. In this example, the sealing element has a shore A hardness of approximately 28.

In this example, the sealing element holder 106 (otherwise termed a puck-holder) includes a side-wall 130. The side-wall 130 in this example is arranged to form a cylinder. The sealing element holder 106 includes a central wall 132 projecting radially inwardly from an upper edge of the side-wall 130. The sealing element holder 106 includes an axial opening 128 for receiving the sealing element 104 in use. In this example, the axial opening 128 is an aperture projecting through central wall 132 of the sealing element holder 106.

The sealing element holder 106 includes coupling arms 136 extending downwardly from the central wall 132 of the sealing element holder 106. The sealing element holder 106 includes openings 148 adjacent each coupling arm 136. In this example the openings are adjacent a corresponding coupling arm 136 in a radially outwardly direction. As shown in FIGS. 6a and 6b, in this example there are four coupling arms 136 arranged equidistantly around the circumference of the sealing element holder 106 with a corresponding opening 148 adjacent each coupling arm 136.

In this example the sealing element holder 106 is made from polypropylene.

The sealing element holder 106 is configured to couple to the vessel 100 by engaging with a surface of the vessel. In this example, the sealing element holder 106 is configured to couple to the vessel 100 by being threadably engaged with a surface of the vessel 100. As shown in FIG. 3, an outer threaded surface 154 of the sealing element holder 106 is configured to threadably engage with a corresponding inner threaded surface 156 of the vessel at a lower end thereof.

A portion of the sealing element 104 is moveable relative to the sealing element holder 106. In this example, a central portion 170 of the sealing element 104 is moveable relative to the sealing element holder 106. That is, the central portion 170 of the sealing element 104 is not directly attached to the sealing element holder 106. The central portion includes the portion of the sealing element 104 located radially inwardly of a recess 124.

The sealing element 104 is coupled to the sealing element holder 106, such that a further portion of the sealing element 104 is fixed relative to the sealing element holder 106. In this example, the sealing element 104 is coupled to the sealing element holder 106 by means of recess 124 running around a circumference of the sealing element 104. The recess 124 mates with a corresponding protrusion 126 on the sealing element holder 106, situated around the circumference of axial opening 128 in sealing element holder 106. Once coupled, the sealing element 104 occupies the axial opening 128. Once coupled, the recess 124 of the sealing element 104 is fixed relative to the sealing element holder 106. That is, the circumference of the sealing element 104 is substantially fixed relative to the sealing element holder 106.

In this example, the base member 108 (otherwise termed a puck) includes a side-wall 134, arranged to form a cylinder. The base member 108 further includes a central wall 138 within the circumference of the side-wall 134, defining the upper and lower surfaces 142,144 of the base member 108.

In this example the base member 108 is made from polypropylene.

The base member 108 includes lips 146 protruding radially inwardly from an upper edge of the side-wall 134. The base member 108 includes openings 168 located radially inwardly from the side-wall 134 adjacent to the lips 146. As shown in FIGS. 7a and 7b, there are four lips 146 protruding from the side-wall 134, with a corresponding opening 168 situated radially inwardly from the side-wall 134 at the same circumferential location as each lip 146.

The base member 108 is located proximate to the sealing element holder 106 in use. That is, the base member 108 is located proximate to the sealing element holder 106 following construction of the assembly. In this example, the base member 108 is situated within an interior of the sealing element holder 106, such that side-wall 134 of the base member 108 is partially surrounded by side-wall 130 of sealing element holder 106 (in this example only a lower portion of side-wall 134 extends below a lower portion of side-wall 130 following construction as shown in FIG. 9a). I.e. the base member 108 is partially surrounded by the sealing element holder 106. The base member is coaxial with the sealing element holder 106.

In this example, the base member 108 is coupled to the sealing element holder 106. To couple the sealing element holder 106 to the base member 108, the sealing element holder 106 is positioned over the base member 108 such that the lips 146 on the side-wall 134 of the base member 108 are aligned with corresponding openings 148 of the sealing element holder 106. The sealing element holder 106 and base member 108 are brought together until the lips 146 on the side-wall 134 contact the corresponding lips 152 on the coupling arms 136. Upon further application of force, the coupling arms 136 will temporarily deform radially inwardly, allowing the lips 146 and 152 to slide past each other, i.e. in a snap-fit. This results in the coupling arms 136 being positioned radially inwardly of the side-wall 134.

Upon relative movement between the sealing element holder 106 and the base member 108 in an opposing direction to that which brought them together, the lips 152 on the coupling arms 136 will engage with the lips 146 of the side-wall 134 to prevent the sealing element holder 106 and base member 108 becoming uncoupled.

The diaphragm element 112 is of circular profile. The diaphragm element 112 includes a skirt portion 158, a coupling portion 160 and a channel 162 running through the centre.

The diaphragm element 112 is coupled to the base member 108. In this example, the diaphragm element 112 is coupled to the base member 108 by coupling member 114. Coupling member 114 includes ridge 164, which is configured to be received by corresponding groove 166 in the base member 108. Upon receipt of the ridge 164 in groove 166, the coupling portion 160 of diaphragm element 112 becomes sandwiched between the coupling member 114 and the base member 108.

The profile of an upper surface of the coupling portion 160 of the diaphragm element 112 corresponds to the profile of a portion of the lower surface 144 of the base member 108, such that once the coupling portion 160 of the diaphragm 112 is engaged with the base member 108, relative lateral movement between the base member 108 and the diaphragm element 112 is limited. The lower profile of the coupling portion 160 of the diaphragm element 112 corresponds to an upper profile of the coupling member 114, such that once the coupling member 114 is engaged with base member 108, relative lateral movement between the diaphragm element 112 and the coupling member 114 is limited.

The ridge 164 is ultrasonically welded to the groove 166 to prevent the coupling member 114 becoming separated from the base member 108.

The diaphragm element 112 is secured to the base member 108 at a position substantially proximate a central region of the lower surface 144 of the base member. That is, the coupling portion 160 of the diaphragm element 112 is located proximate the channel 140. In this example, the coupling portion 160 is directly adjacent the channel 140. The diaphragm element 112 extends across substantially all of the lower surface 144 of the base member.

Following coupling of the diaphragm element 112 to the base member 108 the channel 162 of the diaphragm element 112 is aligned with the channel 140 in base member 108.

The diaphragm element 112 is flexible and resilient to allow it to elastically deform upon contact with a reference surface (as described later). In this example, the diaphragm element 112 is made from silicone.

In this example, the assembly has a diameter (that is, the outer diameter of the sealing element holder 106) of approximately 60 mm. The sealing element holder 106 has a height of approximately 13 mm. The sealing element has a thickness of 3.9 mm.

As will be explained in more detail herein with regards to FIGS. 9a to 9e, in use the sealing element holder 106 is moveable relative to the base member 108 between first and second positions.

FIG. 9a illustrates the assembly 150 as the assembly 150 is brought into contact with a reference surface 102. An end of the skirt portion 158 of the diaphragm element 112 contacts the reference surface 102. The skirt portion 158 is initially inclined relative to the reference surface 102.

FIG. 9b illustrates the assembly 150 with the sealing element holder 106 in the first position relative to the base member 108. That is, the base member 108 and sealing element holder 106 are in a sealing position.

Upon release of the vessel 100 (not shown in FIGS. 9a to 9e), the weight of the vessel 100 and the assembly 150 acts to deform the diaphragm element 112, into the position shown in FIG. 9b, i.e. the skirt portion 158 is flattened relative to the reference surface 102. The skirt portion 158 is deformed until either the base of side-wall 130 of sealing element holder 106 or the base of the side-wall 134 of the base member 108 contacts the reference surface 102.

As the diaphragm element 112 deforms the proportion of the underside of the skirt portion 158 that contacts the reference surface 102 increases. In this example, substantially all of the underside of the skirt portion 158 contacts the reference surface 102.

As the diaphragm element 112 is deformed under the weight of the assembly 150 and vessel 100, the air within the sealed space is ‘squeezed out’ of the sealed space. The air is squeezed out of the sealed space by being forced out between the skirt portion 158 of the diaphragm element 112 and the reference surface 102 and/or by being forced between the sealing surface 110 and the sealing element 104, or a combination thereof.

Once the base member 108 contacts the reference surface 102, the sealing element holder 106 will continue moving towards the reference surface 102 until the base of the side-wall 130 of the sealing element holder 106 contacts the reference surface 102.

As the sealing element holder 106 moves to the first position relative to the base member 108 (i.e. as the sealing element holder 106 moves towards the reference surface 102) the sealing element 104 is compressed against the sealing surface 110 (shown schematically as an interference fit in FIG. 9b) under the weight of the vessel 100 and sealing element holder 106. As the sealing element 104 compresses against the sealing surface 110, the coupling arms 136 are partially received in corresponding openings 168.

The assembly is configured such that when the diaphragm element 112 is engaged with the reference surface 102 and the sealing element holder 106 is in the first position the sealing element 104 will engage with the sealing surface 110 thereby forming a sealed space between the reference surface 102 and the sealing element 104 to anchor the assembly 150 to the reference surface 102.

In this example, the sealing surface 110 is an annular ridge. The annular ridge extends upwardly from the base member 108. The annular ridge provides a small contact area against which the sealing element 104 engages to help ensure a reliable seal. in this example, the annular ridge has an outer diameter of substantially 13 mm and a thickness and height of substantially 1.6 mm. In this example, the sealing element 104 deforms around and over the annular ridge as the small contact area ensures the annular ridge exerts significant local pressure on the sealing element.

The sealed space is partially defined by the sealing element 104, the diaphragm element 112 and the reference surface 102. In this example, the sealed space is further defined by channel 140. The sealed space spans across the underside of the diaphragm element 112, i.e. the sealed space spans across substantially most of the base member 108.

The creation of a sealed space acts to anchor the assembly 150 to the reference surface 102 by creating a sealed volume of air. While the space remains sealed, any movement of the assembly 150, which acts to increase the volume of the sealed space (e.g. slight lifting of the vessel) will result in a reduction of pressure within the sealed space (due to Boyles law). As such, the pressure difference between the relatively high atmospheric pressure and the relatively low pressure within the sealed space, will result in an anchoring force, anchoring the assembly 150 to the reference surface 102.

FIGS. 9c to 9d illustrate how the sealing element holder 106 is brought from the first position to the second position relative to the base member 108. The assembly is configured such that when the sealing element holder 106 is in the second position the diaphragm element 112 is removable from the reference surface 102.

The sealing element holder 106 is configured to move from the first position to the second position upon movement away from the reference surface 102. As the vessel 100, and hence the sealing element holder 106, is raised away from the reference surface 102, the sealing element holder 106 moves relative to the base member 108, which remains anchored to the reference surface 102. The second position is defined as the point at which the sealing element 104 no longer engages the sealing surface 110. That is, when the sealing element holder 106 is in the second position the sealing element 104 is not engaged with the sealing surface 110.

The assembly 150 is configured such that as the sealing element holder 106 moves from the first to second position the sealing element 104 deforms to remain engaged with the sealing surface 110. As shown in FIG. 9c, initially the sealing element 104 remains in contact with the sealing surface 110 and hence deforms as the sealing element holder 106 is moved away from the reference surface 102. I.e. the force applied to lift the vessel 100 (and hence the sealing element holder 106) is sufficient to deform the sealing element 104 but not to overcome the anchoring force, which anchors the sealing element 104 to the sealing surface 110.

The moveable portion of the sealing element 104 deforms (i.e. the central portion in this example) deforms to remain engaged with the sealing surface 110. As such, the sealed space remains sealed upon initial movement of the vessel. That is, the resilience of the sealing element 104 allows the vessel 100 to be raised perpendicular to the reference surface by an amount (i.e. causing a degree of relative movement between the sealing element holder 106 and the base member 108) before the seal is broken. In this example, the amount by which the vessel is raised perpendicular to the reference surface before the seal is broken is approximately 1 mm, i.e. the central portion of the sealing element 104 will deform by approximately 1 mm before it can no longer remain engaged with the sealing surface.

That is, to bring the sealing element holder 106 from the first position to the second position, the vessel (and hence the sealing element holder 106) is raised vertically (i.e. perpendicular to the reference surface 102) by a distance sufficient so that the sealing element 104 is no longer compressed against the sealing surface 110 and by a further distance so that the sealing element 104 is no longer engaged with the sealing surface 110, i.e. no longer ‘stuck’ to the sealing surface (in this example by substantially 1 mm).

The configuration of the sealing element is such that the required relative displacement between the sealing element holder 106 and the base member 108, to displace the sealing element sufficiently to break the seal is enough to ensure accidental knocks to the vessel do not cause the seal to be broken.

The configuration of the sealing element allows a degree of relative out-of-plane rotation between the base member 108 and the sealing element holder 106 without the seal being broken. I.e. if the vessel 100 is knocked slightly, causing the vessel 100 to tip relative to the reference surface 102 (and hence the base member 108), the close tolerance between the base member 108 and the sealing element holder 106 helps ensure relative out-of-plane rotation between the base member 108 and the sealing element holder 106 is minimised and also that the lateral forces on the sealing element are minimised. In addition, the sealing element 104 will deform asymmetrically to help ensure the sealing element 104 remains in contact with the sealing surface 110 and hence maintain the seal.

Upon further movement of the vessel 100, the sealing element holder 106 is eventually lifted until the sealing element 104 no longer contacts the sealing surface (i.e. until the sealing element holder 106 is in the second position), as shown in FIG. 9d. At this point, there is no longer a sealed space and hence there is no longer an anchoring force anchoring the assembly 150 to the reference surface 102. That is, there is no anchoring force anchoring the diaphragm element 112 to the reference surface 102 so the diaphragm element 112 is removable from the reference surface 102.

Upon further movement of the vessel 100, the lips 152 on the coupling arms 136 of the sealing element holder 106 engage with the lips 146 on side-wall 134 of the base member 108, such that the base member 108 and diaphragm element 112 are lifted from the reference surface 102, as shown in FIG. 9e. The vessel and assembly can then be repositioned.

Various modifications to the detailed arrangements as described above are possible. For example, the assembly may be of any suitable dimensions to fit a corresponding vessel. Aptly, the assembly may have a diameter (that is, the outer diameter of the sealing element holder 106) of approximately between 50 and 100 mm. Aptly, the sealing element holder 106 may have a height of approximately between 12 and 25 mm. Aptly, the sealing element may have a thickness of between 1 and 5 mm.

The sealing element holder 106 may have any number of coupling arms 136. For example, there may be 2, 3 or more coupling arms 136. The coupling arms 136 may be arranged at any suitable point on the sealing element holder 106. For example, the coupling arms 136 may/may not be equally spaced around the circumference of the sealing element holder 106.

The sealing element holder 106 may not have openings 148. In such a case, the sealing element holder 106 may be coupled to the base member 108 by positioning the sealing element holder 106 over the base member 108 such that the coupling arms 136 are aligned with corresponding openings 168 of the base member 108, before bringing the sealing element holder 106 and base member 108 together.

There may be any number of openings 168 on base member 108, corresponding to the coupling arms 136. The number of openings 168 (and similarly the number of lips 146) may match the number of coupling arms 136. Alternatively, a single opening 168 may receive more than one coupling arms 136 when the sealing element holder 106 is brought into the first position relative to the base member 108. That is, a single opening 168 may extend around a segment of the circumference of the base member 108, with the segment being large enough such that the opening 168 can receive more than one coupling arm 136.

The sealing element holder 106 may be configured without coupling arms 136. For example, the lips 152 may project radially inwardly from the sidewall 130, with the lips 146 of the base member 108 projecting radially outwardly from the side-wall 134 of the base member 108 to allow engagement of the lips 146 and 152.

The sealing element holder and/or the base member may be made from any suitable material, for example the sealing element holder and/or base member may be made from any rigid plastic, e.g. ABS, polypropylene or nylon.

The central wall 132 may project from any portion of the side-wall 130. For example, the central wall may project from a central portion of the side-wall 130, such that the side-wall 130 may extend above the central wall 132.

Any suitable portion of the sealing element 104 may be fixed relative to the sealing element holder 106. However, fixing the sealing element 104 at a region proximate its circumference only (i.e. away from the central portion) allows the central portion to deform and hence helps maintain the seal upon relative movement between the sealing element holder 10 and the base member 108.

The sealing element holder 106 may be brought from the first to the second position by any suitable movement, provided the vertical component (i.e. perpendicular to the reference surface 102) of the distance moved is sufficient to break the seal, as per the discussion above.

In this example, the sealing element is domed, however the sealing element may be any shape suitable for providing a seal against the sealing surface. For example, the sealing element may be U-shaped in profile or may be a bellowed sealing element.

FIG. 13 illustrates an alternative sealing element 304. In this example, the sealing element 304 has a flat surface 310 for engagement with a sealing surface 110. The sealing element includes a circumferential groove 320, which allows the sealing element to deform more easily to maintain the seal upon relative out-of-plane rotation between the sealing element holder and the base member.

FIG. 11 illustrates another example of an assembly 250, which differs from assembly 150 in that the axial opening 228 is a recess in the sealing element holder 106 (with FIG. 11 corresponding to FIG. 9c for the assembly 250). In this example, the sealing element 104 is secured to the sealing element holder 106 at its circumference, in the same manner as the assembly 150. Specifically, the sealing element 104 is secured to the sealing element holder 106 via recess 124 and protrusions 126.

FIG. 12 illustrates another example of an assembly 350, which differs from assembly 150 in that the axial opening 328 is a groove (with FIG. 12 corresponding to FIG. 9c for the assembly 250). In this example, the sealing element 204 is secured to the sealing element holder 106 by an annular protrusion 330, which is configured to mate with the groove 328.

The sealing element 104 may be made from any suitable material. That is, the sealing element 104 may be made from any suitable flexible, resilient material, for example a suitable polymer/co-polymer. The sealing element 104 may be made from silicone for example.

Aptly, the sealing element 104 has a shore A hardness between approximately 20 and 50. More aptly, the sealing element 104 has a shore A hardness between approximately 25 and 40.

Depending on the material used and the thickness of the sealing element 104, the sealing element may deform by any amount to remain engaged with the sealing surface as the sealing element holder 106 moves from the first to the second position. Aptly, the sealing element 104 may deform by between approximately 0.5 and 2 mm. The flexibility of the sealing element may be tuned by adjusting the hardness and thickness of the material used. For example, a harder, thicker sealing element reduces the deformation compared to a softer, thinner sealing element. Tuning the flexibility of the sealing element allows the resistance needed to be overcome to release the suction to be altered, for example depending on use with infants or adults.

Changing the diameter of the sealing element 104 may also help tune the sealing element. For example, a larger diameter sealing element (when supported only at a position substantially proximate its circumference), will increase the amount by which it can deform to remain engaged with the sealing surface compared to a sealing element with a smaller diameter.

The sealing element 104 may be coupled to the sealing element holder 106 in any suitable way. For example, the sealing element 104 may be adhered to the sealing element holder 106 using a suitable adhesive. Adhesive may be used in addition to the recess/protrusion or groove/annular protrusion arrangements described above. Adhesive may be used as an alternative to the recess/protrusion or groove/annular protrusion arrangements described above.

In the example of FIGS. 9a to 9e, the sealing element 104 is also compressed against a further annular ridge 176 (as labelled in FIG. 5), situated on an upper surface 142 of base member 108, as the sealing element holder 106 is brought to the first position. The further annular ridge 176 is located radially outwardly from the sealing surface, such that the further annular ridge defines a circle that encompasses the sealing surface within the defined circle. Compression of the sealing element 104 against the annular ridge 176 provides redundancy in the eventuality of failure of the seal between the sealing element 104 and the sealing surface 110. The further annular ridge is optional. Alternatively, there may be any number of further annular ridges to provide sealing redundancy.

The sealing element 104 may be moulded directly onto the sealing element holder 106. Alternatively, the sealing element 104 may be coupled to the sealing element holder 106 by a press-fit connection.

FIG. 14 illustrates another example of a sealing element 404. In this example, the sealing element has an inwardly turned annular coupling protrusion 410, for mating with a corresponding outwardly turned annular coupling protrusion 420 on the sealing element holder 106. Alternatively, the coupling protrusion 420 may be inwardly turned and the coupling protrusion 410 may be outwardly turned.

The sealing element 104 may include an annular ridge for engagement with the sealing surface 110. The annular ridge of the sealing element 104 may be as an alternative to the annular ridge of the sealing surface 110. Alternatively, the annular ridge of the sealing element 104 may be in addition to the annular ridge of the sealing surface 110.

The annular ridge may be of any suitable dimensions to ensure a tight seal and minimise the volume of air left in the sealed space. Aptly, the annular ridge may have an outer diameter of between 7 and 20 mm. More aptly, the annular ridge may have an outer diameter of between 10 and 15 mm. When the sealing element holder 106 is in the first position, the sealing element 104 may be deformed over the annular ridge by any suitable amount for the purposes of creating an effective seal. Aptly, the sealing element 104 may deform around and over the annular ridge such that between 10 and 100% of the surface of the annular ridge is surrounded by the sealing element 104, with the amount the sealing element deforms around and over the annular ridge depending on the properties and dimensions of the sealing element.

The sealing surface 110 may be any surface suitable for the sealing element to seal against. FIG. 15 illustrates a further example of a sealing surface 210 of a base member 108. In this example, the sealing surface 210 includes a curved surface, curving downwardly towards the channel 140. The curved surface is configured to maximise contact area between a sealing element 504 (shown without a sealing element holder) and the curved surface, with the surface of the sealing element 504 substantially matching the sealing surface 210. In this way, the sealing element plugs most of the recessed sealing surface, such that a reliable seal is formed without significant deformation to the sealing element. The contact between the sealing element 504 and the sealing surface 210 also helps to minimise the volume of air in the sealed space to provide a relatively strong and reliable seal.

The base member 108 may be coupled to sealing element holder 106 in any known way.

Alternatively, the base member 108 may not be coupled to the sealing element holder 106. For example, neither the base member 108 nor the sealing holder 106 may include lips, such that when the sealing element holder 106 is moved related to the base member 108, there may be nothing to prevent the sealing element holder 106 and base member 108 moving apart.

The first position of the base member 108 relative to the sealing element holder 106 may not involve contact between the base of side-walls 134 and the reference surface 102. The diaphragm element 112 may have sufficient rigidity to support the assembly 150 in an elevated position from the reference surface 102. Similarly, the first position of the base member 108 relative to the sealing element holder 106 may not involve contact between the base of the side-walls 130 of the sealing element holder 106 and the reference surface 102.

The base member 108 may be uncoupled from the sealing element holder 106. As shown in FIGS. 10a and 10b, the coupling member 114 may include a slot 168 to assist in uncoupling the base member 108 from the sealing element holder 106. Rotation of the slot in either direction causes the base member 108, to which the coupling member 114 is coupled, to also rotate. In this example, due to the close tolerance between the base member 108 and the sealing element holder 106, rotation of the base member 108 also causes the sealing element holder 106 to rotate, allowing removal of the assembly 150 from the vessel 100.

In the above described examples, the sealing element holder 106 includes prongs 172, configured to couple with corresponding recesses 174 in the base member 108, to help prevent relative rotation between the base member 108 and the sealing element holder 106 and therefore help ensure the assembly 150 can be removed in its entirety from vessel 100.

Alternatively, or additionally, relative rotation between the base member 108 and the sealing element holder 106 may be prevented by providing pins arranged to locate with corresponding bores. As shown in FIGS. 16a, the sealing element holder 106 is provided with four pins 652 extending from its underside. A corresponding set of four bores 650 suitable for receiving the pins is located on the upper surface of the base member 108, as shown in FIG. 16b. The pins and bores are arranged such that when the sealing element holder 106 is coupled to the base member 108, as shown in FIG. 17, each pin 652 locates into a bore 650 such that the pin 652 engages the walls of the bore 650 and while still moving freely in an coaxial direction.

In this way, the combination of prongs 172 and recesses 174 and/or the combination of pins 652 and bores 650 ensure relative movement between the base member 108 and the sealing element holder 106, when moving between first and second positions, is limited to a substantially coaxial direction.

Furthermore, the same features minimise relative tilting between the base member 108 and the sealing element holder 106. Consequently, the sealing surface 110 is maintained substantially parallel to lower surface of the sealing element 104 in order that sideways force on the vessel 100 will not substantially lift one edge of the sealing element 104, releasing the anchoring force prematurely.

Optionally, the base member 108 and sealing element holder 106 may be provided with any appropriate number of cooperating pins or bores. Furthermore, some or all of the pins may alternatively be provided on the upper surface of the base member 108, with cooperating bores arranged on the underside of the sealing element holder 106. Other co-axial locating means as known in the art, such as the prongs and recesses, may be provided instead of or in addition to the pins and bores.

Alternatively, the tolerance between the base member and the sealing element holder may not be so close so as to prevent relative rotation between the base member and the sealing element holder around their common axis. In such an example, rotation of the base member may result in the misalignment of the lips 146 of the side-wall 134 with the coupling arms 136 (specifically the lips 152 of the coupling arms 136 of the sealing element holder 106), such that coupling arms 136 can slide past the side-wall 134 and hence the base member 108, the diaphragm element 112 and the coupling member 114 can be removed as a single entity from the sealing element holder 106.

Once the base member 108, the diaphragm element 112 and the coupling member 114 have been removed, the sealing element holder 106 becomes more accessible such that it becomes easier to uncouple (i.e. unscrew in the illustrated example) the sealing element holder 106 from the vessel 100.

The base member 108 may be at least partially surrounded by the sealing element holder 106. Alternatively, the base member 108 may be entirely surrounded by the sealing element holder 106 in use. That is the side-wall 134 of the base member 108 may be at least partially or entirely surrounded by the side-wall 130 of the sealing element holder 106 in use (i.e. when the assembly 150 is assembled).

The diaphragm element 112 may be coupled to base member 108 in any suitable manner. For example, the diaphragm element 112 may be pinned or adhered to the base member 108. The diaphragm element 112 may be removably coupled to the base member 108.

The diaphragm may be any suitably flexible material, for example TPE or silicone.

The diaphragm and coupling member may be moulded as a single component.

The diaphragm may support the assembly and the vessel. That is, neither the base member or the sealing element holder may rest on the reference surface when the sealing element holder is in the first position.

The sealed space may be fully defined by the sealing element 104, the diaphragm element 112 and the reference surface 102. For example, in an embodiment where the diaphragm element 112 was directly coupled to the base member 108 (i.e. without the necessity of coupling member 114) and said coupling was along an inner surface of channel 140, the sealing element, the diaphragm element 112 and reference surface 102 may fully define the sealed space.

The sealing element holder 106 may be configured to couple to the vessel 100 in any suitable way. For example, the sealing element holder 106 may be coupled to the vessel 100 by a snap-fit attachment. Alternatively, the sealing element holder 106 may be coupled to the vessel 100 by being integrally formed with the vessel 100.

Particularly (but not exclusively) for an example where the sealing element holder 106 is integrally formed with the vessel, the base member 108 and the diaphragm element 112 may be provided as a separate assembly. That is, an assembly (i.e. a sub-assembly of the previously defined assembly) for anchoring a vessel, including a sealing element holder having a sealing element coupled thereto, to a reference surface, may be provided. This assembly includes a base member for locating proximate to a sealing element holder coupled to a vessel in use, wherein the sealing element holder is moveable relative to the base member between first and second positions. This assembly further includes a diaphragm element coupled to the base member for engagement with a reference surface. The base member includes upper and lower surfaces, a sealing surface on the upper surface and a channel extending from the upper surface to the lower surface. The assembly is configured such that when the diaphragm element is engaged with the reference surface and the sealing element holder is in the first position the sealing element will engage with the sealing surface thereby forming a sealed space between the reference surface and the sealing element to anchor the assembly to the reference surface. The assembly is configured such that when the sealing element holder is in the second position the diaphragm is removable from the reference surface.

The assembly (or a sub-assembly thereof) may be provided as a kit of parts for anchoring a vessel to a reference surface, including a sealing element holder for coupling to a vessel, a sealing element for coupling to the sealing element holder, wherein a portion of the sealing element is moveable relative to the sealing element holder in use. The kit of parts (or a separate kit of parts) may further include a base member for locating proximate to the sealing element holder in use, and a diaphragm element for coupling to the base member for engagement with a reference surface, wherein the base member comprises upper and lower surfaces, a sealing surface on the upper surface and a channel extending from the upper surface to the lower surface. In use, the sealing element holder is moveable relative to the base member between first and second positions. In use, the assembled kit of parts is configured such that when the diaphragm element is engaged with the reference surface and the sealing element holder is in the first position the sealing element will engage with the sealing surface thereby forming a sealed space between the reference surface and the sealing element to anchor the assembled kit of parts to the reference surface. In use, the assembled kit of parts is configured such that when the sealing element holder is in the second position the diaphragm is removable from the reference surface.

The use of a detachable coupling between the sealing element holder 106 and the vessel 100 provides the advantage that the system is modular so that the sealing element holder 106 can be removed from a first vessel and then coupled with a second vessel. As such, a single assembly including a sealing element holder 106, a base member 108 and a diaphragm element 112 may be used to anchor several different vessels to a reference surface successively.

In addition, the modular system allows the assembly to be removed from the vessel and cleaned.

Similarly, the use of a detachable coupling between the sealing element holder 106 and the base member 108 allows the assembly to be cleaned more effectively.

The screw thread between the sealing element holder 106 and the vessel 100 provides a tight fit.

The use of a resilient sealing element to seal the sealed space provides the advantage that no intermediate configuration is required within the assembly to accommodate a degree of relative movement between the sealing element holder 106 and the base member 108. The initial compression of the sealing element over the sealing surface when the sealing element holder is in a first position, provides an initial distance through which the sealing element holder may move relative to the base element without the seal being broken. The resilience of the sealing element means that the sealing element ‘sticks’ to the sealing surface as the sealing element holder moves further away from the base member. Only when the sealing element holder is moved relative to the base member by a sufficient distance that the sealing element no longer ‘sticks’ to the sealing surface, will the seal be broken.

The span of the diaphragm element 112 across substantially the entire span of the assembly helps ensure a reliable seal can be formed on dirty or uneven surfaces due to its large contact area. Similarly, the large proportion of the underside of the diaphragm element 112 in contact with the reference surface 102 (aptly between 20 and 100% of the underside of the skirt portion) helps ensure a reliable seal can be formed on dirty or uneven surfaces due to its large contact area.

Configuring a portion of the sealing element to be moveable relative to the sealing element holder (for example by not being directly coupled to the sealing element holder and/or being located in an axial opening) helps to ensure that the sealing element is not restricted and is allowed to deform.

Certain embodiments provide the advantage that engagement between the sealing element and the annular ridge provides a high sealing force due to the small contact area between the sealing element and the annular ridge. This provides a much more reliable seal in comparison to known systems.

Having the base member at least partially surrounded by the sealing element holder in use helps to ensure that it is not necessary to have a ‘double-walled’ vessel, similar to the prior art systems. Specifically, housing a compact base member within a sealing element holder in the manner described above, allows a reliable seal to be created without the necessity of substantial excess material.

It will be clear to a person skilled in the art that features described in relation to any of the embodiments described above can be applicable interchangeably between the different embodiments. The embodiments described above are examples to illustrate additional various features.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect or embodiment are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-26. (canceled)

27. An assembly for anchoring a vessel to a reference surface, the assembly comprising:
a body for coupling to the vessel, the body configured to hold a sealing element;
a seal coupled to the body, wherein at least a portion of the seal is moveable relative to the body;
a base coupled to the body, wherein at least a portion of the base is moveable relative to the body; and
a diaphragm coupled to the base for engagement with a reference surface;
wherein the base comprises:
upper and lower surfaces;
a sealing surface on the upper surface; and
a channel extending from the upper surface to the lower surface;
wherein the body is moveable relative to the base between first and second positions;
wherein the assembly is configured such that when the diaphragm is engaged with the reference surface and the body is in the first position the seal will engage with the sealing surface to form a sealed space defined by at least the seal, the diaphragm and the reference surface to anchor the assembly to the reference surface, and
wherein the assembly is configured such that when the body is in the second position the diaphragm is removable from the reference surface.

28. The assembly according to claim 1, wherein at least a portion of the seal is deformable under pressure.

29. The assembly according to claim 1, wherein the seal comprises an elastomeric material.

30. The assembly according to claim 1, wherein at least one of the sealing surface or seal comprises an annular ridge configured to form the sealed space.

31. The assembly according to claim 1, wherein the seal is substantially domed.

32. The assembly according to claim 1, wherein when the body is in the first position, the assembly is anchored to the reference surface by suction.

33. The assembly according to claim 1, wherein the assembly is configured such that as the body moves from the first to the second position, a portion of the seal remains engaged with the sealing surface.

34. The assembly according to claim 1, wherein when the body is in the second position the seal is not engaged with the sealing surface.

35. The assembly according to claim 1, wherein the body is configured to move from the first position to the second position when the weight of the vessel is removed from the assembly.

36. The assembly according to claim 1, wherein the base is at least partially surrounded by the body.

37. The assembly according to claim 1, wherein the base is coaxial with the body.

38. The assembly according to claim 1, wherein at least one of the body or the base is configured to limit relative rotation therebetween using a plurality of prongs configured to couple with corresponding recesses.

39. The assembly according to claim 1, wherein the base is coupled to the body by at least one lip protruding radially inwardly from an upper edge of a side wall of the base coupled to a corresponding at least one lip projecting radially outwardly from the body.

40. The assembly according to claim 1, wherein the body is configured to removably engage with the vessel.

41. The assembly according to claim 1, wherein the diaphragm is secured to the base at the center of the lower surface of the base.

42. The assembly according to claim 1, wherein the diaphragm extends across most of the lower surface of the base.

43. An assembly comprising:
a body for coupling to a vessel for anchoring the vessel to a reference surface, the body holding a seal wherein a portion of the seal is moveable relative to the body;
a base coupled to the body wherein at least a portion of the base is moveable relative to the body, the base comprising an upper sealing surface and a lower surface, and a channel extending from the upper sealing surface to the lower surface; and
a diaphragm coupled to the base for engagement with a reference surface;
wherein the body is moveable relative to the base to create a sealed space when the seal is engaged with the sealing surface;
wherein the sealed space is defined by at least the seal, the diaphragm and the reference surface to anchor the assembly to the reference surface; and
wherein when the seal disengages from the sealing surface, the diaphragm is removable from the reference surface.

44. The assembly according to claim 17, wherein the weight of the vessel when placed on the reference surface coupled to the body causes the body to move towards the base to create the sealed space anchoring the vessel to the reference surface by suction.

45. The assembly according to claim 17, wherein the body is configured to move away from the base by approximately 1 mm before the seal disengages from the sealing surface.

46. A method for removably anchoring a vessel to a reference surface, the method comprising:
providing a vessel;
providing an assembly coupled to the vessel, the assembly comprising:
a body having a seal;
a base coupled to the body wherein the base is moveable relative to the body, the base having an upper surface for engaging the seal, a lower surface, and a channel extending from the upper surface to the lower surface; and
a diaphragm coupled to the base for anchoring to and releasing from the reference surface;
placing the vessel on the reference surface, wherein the weight of the vessel causes the body to move relative to the base to create a sealed space wherein the sealed space is defined by at least the seal, the diaphragm and the reference surface to anchor the assembly to the reference surface by suction; and
lifting the vessel from the reference surface, wherein when the weight of the vessel is removed, the body moves in a substantially opposite direction relative to the base to disengage the seal from the sealing surface breaking the suction and allowing the diaphragm to lift from the reference surface.
